(19) United States
(12) Patent Application Publication
(10) Pub. No.: US 2002/0063152 A1
(43) Pub. Date: May 30, 2002

(54) Card data processing method for a network kiosk

(75) Inventors: John C. Goodwin III, Suwanee, GA (US); John Brian Francis, Alpharetta, GA (US)

Correspondence Address: Paul W. Martin, NCR Corporation, Law Department, ECD-2, 101 West Schantz Avenue, Dayton, OH, 45479-0001, US

(73) Assignee: NCR Corporation

(21) Appl. No.: 09/727,333

(22) Filed: Nov. 29, 2000

(51) Int. Cl. G06K 5/00

(52) U.S. Cl. 235/380

(57) ABSTRACT

A card data processing method for a network kiosk which automatically prompts for card data to be displayed in a web page. The method includes the steps of displaying a web page, displaying a prompt associated with the web page to have an operator use a card reader to read card data stored by an operator card, and receiving the card data from the card reader.

### BACKGROUND OF THE INVENTION

The present invention relates to self-service kiosks and more specifically to a card data processing method for a network kiosk.

Retailers have a desire to sell their products over networks, such as global networks which are a part of the World Wide Web (WWW or “web”) and which use the Transmission Control Protocol/Internet Protocol (TCP/IP protocol). These retailers wish to provide Internet server web sites which offer the same features as Internet server web sites available to home shoppers who use their computers to connect to the server web sites.

Kiosks provide a publicly-accessible computing platform for displaying web pages from retailer web sites. Kiosks may be located within a retailer's transaction establishment or elsewhere, such as in shopping malls. Kiosks may be easily networked to retailer web sites using the TCP/IP protocol. Web pages from web sites may be displayed using known and available web software, such as Microsoft® Internet Explorer software.

Kiosks may receive input data from various sources. For example, kiosks may include card readers for facilitating customer payment for products and customer access to loyalty program awards. Kiosks which include touch screens rather than keyboards make entry of personal information, such as credit card information, more difficult.

It would be desirable to provide a card data processing method for a network kiosk which automatically enters captured card data into a transaction web page.

### SUMMARY OF THE INVENTION

In accordance with the teachings of the present invention, a card data processing method for a network kiosk is provided.

The method includes the steps of displaying a web page, displaying a prompt associated with the web page to have an operator use a card reader to read card data stored by an operator card, and receiving the card data from the card reader. It is accordingly an object of the present invention to provide a card data processing method for a network kiosk.

It is another object of the present invention to automatically display captured card data in a web page.

It is another object of the present invention to activate certain links to web content related to the card data following capture of the card data.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a transaction processing system including a network kiosk;

FIG. 2 is a depiction of a card data configuration file; and

FIGS. 3A and 3B form a flow diagram illustrating the card data processing method of the present invention.

### DETAILED DESCRIPTION OF THE PREFERRED EMBODIMENT

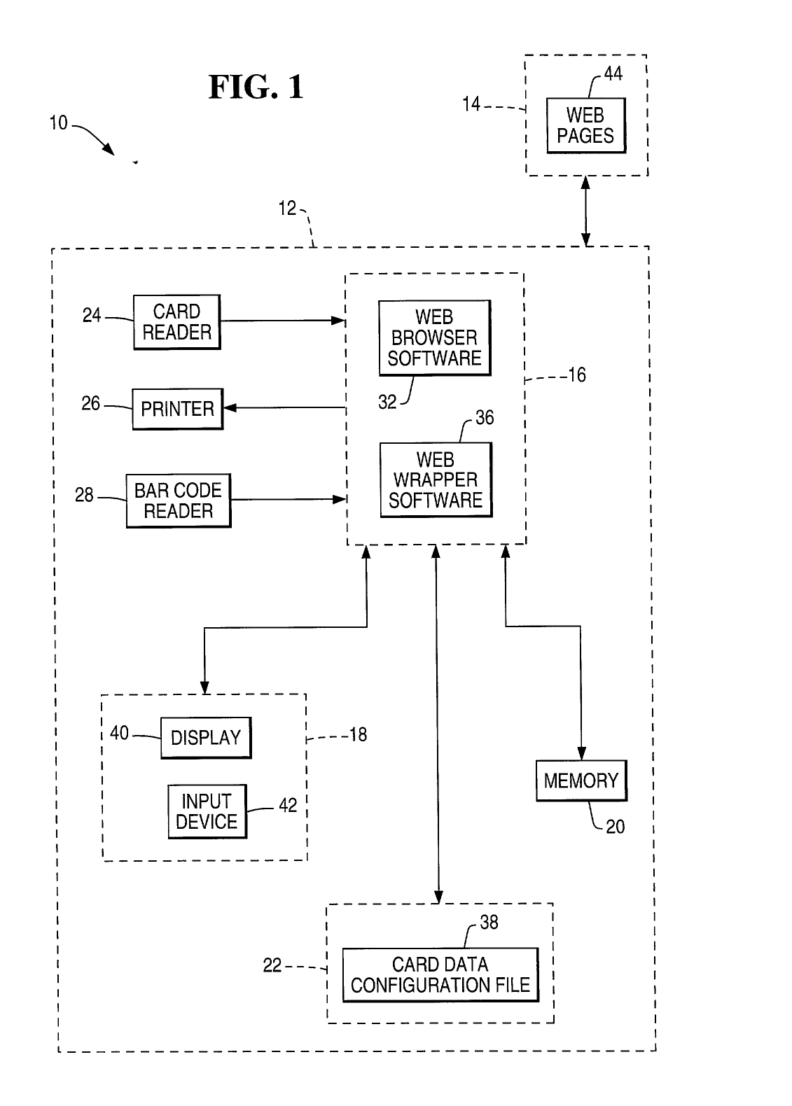

Turning now to FIG. 1, transaction system 10 includes kiosk 12 and network 14. Kiosk 12 is preferably located within a transaction establishment, such as a retail store, or transaction environment, such as a shopping mall.

Kiosk 12 primarily includes processor 16, touch screen 18, memory 20, and storage medium 22. Kiosk 12 may additionally include a number of peripherals, including card reader 24, printer 26, and bar code reader 28.

To assist with execution of certain tasks performed by kiosk 12, kiosk 12 includes a built-in time keeping device, commonly referred to as a system clock, which is synchronized with current time, in order to automatically execute the tasks at their scheduled times.

Processor 16 controls operation of kiosk 12 and executes web browser software 32 and web wrapper software 36.

Web browser software 32 allows an operator to access information and purchase products from retailers through network 14, which preferably includes World Wide Web (WWW or “web”) servers. Web browser software 32 may include commercially-available web browser software, such as Microsoft® Internet Explorer web browser software. Microsoft® Internet Explorer web browser software is configured into a kiosk operation using a “-k” command line option. This option hides toolbars and menubars to prevent operator access to those functions.

Web browser software 32 retrieves and displays web pages 44 from network 14, which includes a plurality of interconnected servers Web pages 44 include web pages which display information about products and services offered by the kiosk owner as well as other web pages. Web pages 44 assist operators to find information about products sold by the kiosk owner and to complete purchases of such products. For this purpose, web pages 34 may include a start or “home” page which operates as a default page from which operation begins and to which operation returns when an operator is finished using kiosk 12. Web pages 44 may be written using hypertext markup language (HTML) or other suitable web page language.

Web wrapper software 36 provides security functions. During operation, web wrapper software 36 prevents an operator from accessing kiosk files, other applications, the operating system software, or basic input-output system (BIOS) firmware, and prevents the operator from causing kiosk 12 to reboot.

Under the present invention, web wrapper software 36 additionally enables card reader 24 when web browser software 32 is displaying a web page which contains fields for storing recorded card data or hypertext links to other content, including web pages, which rely on or are related to recorded card data. Web wrapper software 36 then enables input to those hypertext fields or links. A listing of web pages which are associated with card data information may be coded into web wrapper software 36 or listed in card data configuration file 38 to allow a kiosk owner to control operation.

Touch screen 18 includes display 40 and input device 42. Display 40 and input device 42 may also be separate units. Input device 42 may record personal information from an operator.

Memory 20 is used by processor 16 to store executed program information, including web wrapper software information.

Storage medium 22 stores software including web wrapper software 36.

Card reader 24 reads operator cards, which may include loyalty, credit, debit, smart, and/or other types of cards carried by an operator, such as a customer. For this purpose, card reader 24 may include a magnetic stripe reader (MSR) or smart card reader. Card reader 24 may record personal information of the operator.

Printer 26 prints information from web wrapper software 32, including information on web pages 44 from network 14. For example, printer 26 may print information relevant to a transaction completed by an operator using kiosk 12.

Bar code reader 28 reads bar codes on products to obtain product identification numbers. Kiosk 12 queries a transaction server with the identification numbers to obtain information about the product and displays the information.

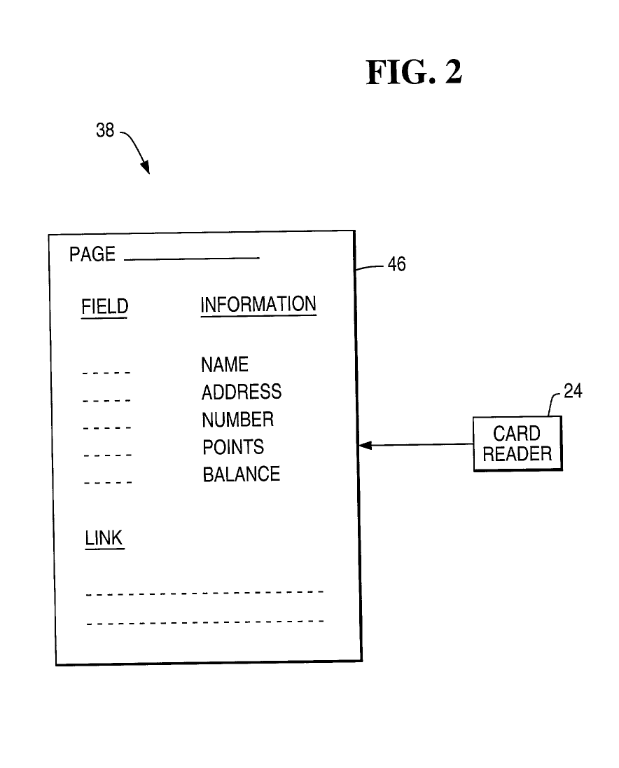

Turning now to FIG. 2, card data configuration file 38 includes record 46 for each web page 44 that contains fields for storing recorded card data or hypertext links to other content, including web pages, which rely on recorded card data. Each record 46 includes entries PAGE, LINK, FIELD, and INFORMATION.

Entry PAGE identifies a particular web page 44 which contains fields for storing recorded card data or hypertext links to other content, including web pages, which rely on recorded card data.

Entry LINK identifies hypertext links in each web page 44 identified in card data configuration file 38, including links to web pages, which rely on recorded card data. These links are functional only when web wrapper software 36 has enabled reading of card data by card reader 24.

Entry INFORMATION identifies types of information obtained from a card by web wrapper software 36.

Entry FIELD identifies fields in each web page 44 identified in card data configuration file 38 which are mapped to the retrieved card data from card reader 24 in entries INFORMATION.

In operation, web wrapper software 36 compares an address of a displayed page to entries PAGE in card data configuration file 38. If the address of the displayed page is located within card data configuration file 38, web wrapper software 36 enables reading of cards by card reader 24 and data storage in fields for storing card data. Web wrapper software 36 obtains recorded card data from card reader 24 and uses the mappings of entries INFORMATION to entries FIELD to display the retrieved card data in fields in the displayed web page. Web wrapper software 36 also enables hypertext links under entries LINK.

For example, suppose web browser software 32 is displaying a web page for completing payment for an on-line transaction. Suppose that the web page includes fields which must be filled out by the customer. These fields include Name fields (First, Middle Initial, and Last) and Credit Card fields (credit card number, credit card type, and credit card expiration date) Web wrapper software 36 displays a prompt to the customer to swipe a credit card through card reader 24. After the customer has swiped the credit card, web wrapper software 36 obtains track information contained in the credit card's magnetic stripe and automatically populates the Name and Credit card fields using the track information. Advantageously, the present invention facilitates faster finalization of on-line transactions.

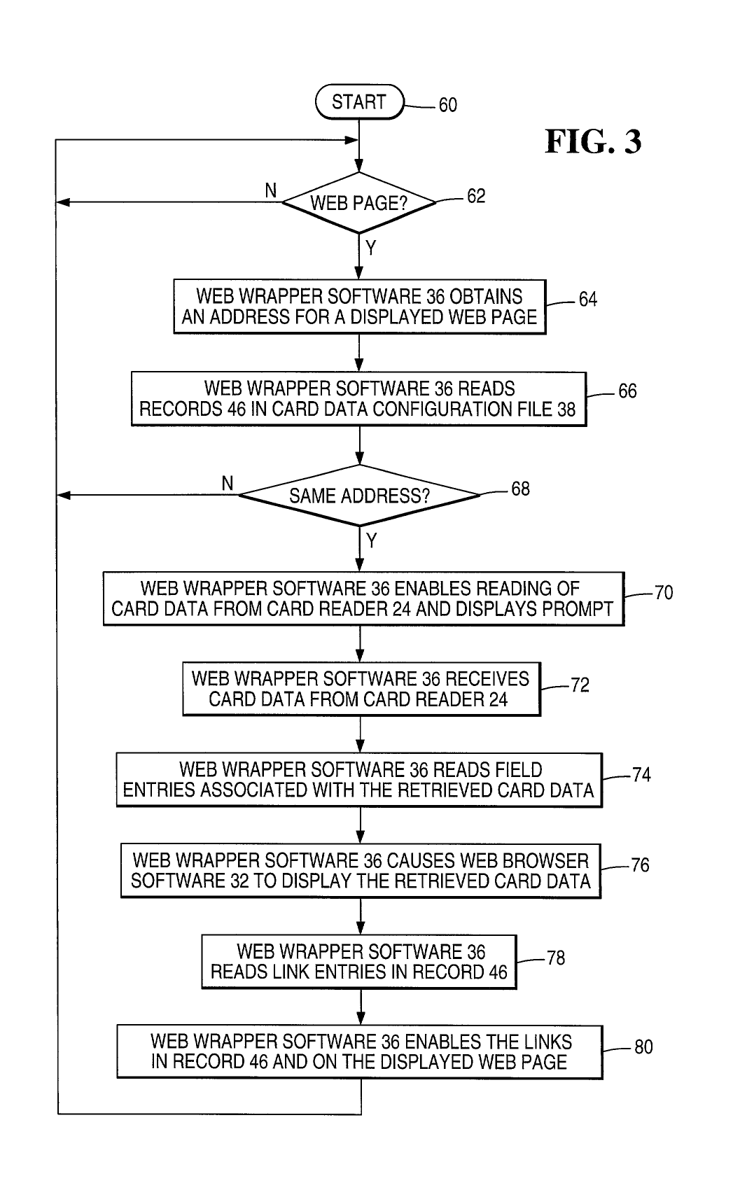

Turning now to FIG. 3, the method of the present invention is illustrated beginning with START 60.

In step 62, web wrapper software 36 waits for another web page to be displayed.

In step 64, web wrapper software 36 obtains an address for a displayed web page.

In step 66, web wrapper software 36 reads records 46 in card data configuration file 38.

In step 68, web wrapper software 36 compares PAGE entries in records 46 with the address of the displayed page. If one of the PAGE entries in records 46 is the same as the address of the displayed page, operation proceeds to step 70. Otherwise, operation returns to step 62 to wait for another web page to be displayed.

In step 70, web wrapper software 36 enables reading of cards by card reader 24 and displays a prompt to the operator to use card reader 24.

In step 72, web wrapper software 36 receives card data from card reader 24.

In step 74, web wrapper software 36 reads FIELD entries associated with the retrieved card data and INFORMATION entries in record 46 to determine where the card data should be displayed. In the example in FIG. 2, name information maps to the first field, address information maps to the second field, card number information maps to the third field, points information maps to the fourth field, and balance information maps to the fifth field.

In step 76, web wrapper software 36 causes web browser software 32 to display the retrieved card data in the corresponding fields of the displayed web page. Web wrapper software 36 automatically populates the fields with the retrieved data.

In step 78, web wrapper software 36 reads LINK entries in record 46.

In step 80, web wrapper software 36 enables the links in record 46 on the displayed web page.

Operation then returns to step 62 to wait for another web page to be displayed.

Although the present invention has been described with particular reference to certain preferred embodiments thereof, variations and modifications of the present invention can be effected within the spirit and scope of the following claims.

We claim:

1. A card data processing method for a network kiosk comprising the steps of:
displaying a web page;
displaying a prompt associated with the web page to have an operator use a card reader to read card data stored by an operator card; and
receiving the card data from the card reader.

2. The method as recited in claim 1, further comprising the steps of:
determining a number of links to web content associated with the card data in the web page; and
enabling the links.

3. The method as recited in claim 1, further comprising the step of:
displaying the card data in a number of locations in the web page designated to display the card data.

4. A card data processing method for a network kiosk comprising the steps of:
displaying a web page containing a number of locations for displaying card data stored by an operator card;
displaying a prompt associated with the web page to have an operator use a card reader to read the card data;
receiving the card data from the card reader; and
displaying the card data in the locations.

5. A card data processing method for a network kiosk comprising the steps of:
displaying a web page;
displaying a prompt associated with the web page to have an operator use a card reader to read card data stored by an operator card;
receiving the card data from the card reader;
determining a number of links to web content associated with the card data in the web page; and
enabling the links.

6. A card data processing method for a network kiosk comprising the steps of:
displaying a web page including a number of locations for displaying card data stored by an operator card;
displaying a prompt associated with the web page to have an operator use a card reader to read the card data;
receiving the card data from the card reader;
determining a first location in the web page for displaying the card data; and
displaying the card data in the first location.

7. A card data processing method for a network kiosk comprising the steps of:
displaying a web page including a number of locations for displaying card data stored by an operator card;
activating a card reader;
displaying a prompt associated with the web page to have an operator use the card reader to read the card data;
determining a first location in the web page for displaying the card data; and
displaying the card data in the first location.

8. A network kiosk comprising:
a display for displaying a web page containing a number of locations for displaying card data stored by an operator card;
a card reader for reading the card data; and
a computer which displays the web page, activates the card reader, displays a prompt associated with the web page to have an operator use the card reader to read the card data, receives the card data from the card reader, determines a first location in the web page for displaying the card data, and displays the card data in the first location.
